(19) United States
(12) Patent Application Publication
(10) Pub. No.: US 2021/0166847 A1
(43) Pub. Date: Jun. 3, 2021

(54) MANUFACTURING METHOD OF SINTERED ND-FE-B PERMANENT MAGNET

(71) Applicant: Yantai Shougang Magnetic Materials Inc, Yantai (CN)

(72) Inventors: Chunjie XIANG, Yantai (CN); Zhongjie PENG, Yantai (CN); Xiulei CHEN, Yantai (CN); Xiaonan ZHU, Yantai (CN); Qiang ZHANG, Yantai (CN); Kaihong DING, Yantai (CN)

(21) Appl. No.: 17/105,537

(22) Filed: Nov. 26, 2020

(30) Foreign Application Priority Data
Nov. 28, 2019 (CN) 201911194386.3

(51) Int. Cl. H01F 1/057; B22F 1/00; B22F 3/12; B22F 9/04; C22C 38/00; C22C 38/10; C22C 38/06; C22C 38/14; H01F 41/02

(52) U.S. Cl. CPC H01F 1/0576; B22F 9/08; B22F 1/0059; B22F 3/12; B22F 1/0048; B22F 9/04; C22C 38/005; C22C 38/10; C22C 38/06; C22C 38/14; C22C 38/002; H01F 1/0577; H01F 41/0266; B22F 2304/054; B22F 2202/05; B22F 2201/20; B22F 2301/355; B22F 2304/10; B22F 2009/044; B22F 1/0018

(57) ABSTRACT

The present disclosure refers to a preparation method for improving the coercive force of a sintered Nd—Fe—B magnet and comprises:
preparing Nd—Fe—B alloy flakes by a strip casting process, followed by hydrogen decrepitation of the Nd—Fe—B alloy flakes and jet milling to obtain an Nd—Fe—B powder;
mixing Nd—Fe—B powder and an amount of 0.1 to 5 wt. % of a nanoparticulate powder in a powder mixing machine to obtain a powder mixture;
modification of the powder mixture obtained in step B) under inert conditions in a mechanical mixing equipment such that the particles of the Nd—Fe—B powder are rounded and the nanoparticulate powder adheres to the particle surface of the Nd—Fe—B powder;
mixing in a lubricant to the modified Nd—Fe—B powder in a powder mixing machine; and
align pressing the modified Nd—Fe—B powder into a green body, sintering the green body, and aging of the obtained sintered Nd—Fe—B magnet.

### TECHNICAL FIELD

The present disclosure belongs to the technical field of Nd—Fe—B permanent magnets, in particular relates to a manufacturing method of sintered Nd—Fe—B permanent magnets.

### BACKGROUND

Nd—Fe—B magnets are widely used in many technical fields like information technology, rail transit, aerospace, and so on.

With the development of high and new technologies, the demand for Nd—Fe—B magnets of low cost and having high coercivity and high temperature stability has increased dramatically in many technological fields.

How to improve the coercivity of magnets while reducing the total amount of rare earth and the heavy rare earth content is one of the research hotspots at present.

Heavy rare earth elements like Dy or Tb, which have larger magnetocrystalline anisotropy field constants, are usually added into the magnet alloy to enhance the coercive force of the magnets. However, the magnetic moment of heavy rare earth elements and iron atoms is antiferromagnetic, this will lead to a decrease of magnetic remanence and increase the production costs, which limits their application of Nd—Fe—B.

Through the grain boundary diffusion process, like coating the surface of the magnet with oxides or fluorides of heavy rare earth Dy or Tb, and conducting heat treatment to form (Nd,Dy/Tb)2Fe14B magnetically hardened layer at the grain boundary is another way to improve coercive force of magnets. Besides, a low melting point alloy powder without heavy rare earth is used as a diffusion source to improve the distribution of the grain boundary phase, so as to improve the coercive force.

In order to improve the magnetic properties, modifying the Nd—Fe—B powder to optimize the microstructure and structure of magnet is known. CN1110021467A refers to a method for manufacturing magnets including mixing the Nd—Fe—B powder with an organic solution containing heavy rare earth elements, so that the heavy rare earth element is coated around the magnetic particle, in order to control the distribution and diffusion of heavy rare earth element, so as to improve the magnetic property of the magnet.

CN1110021467A refers to a method of manufacturing magnets. A heavy rare earth suspension prepared by a multi-stage grinding process is added to the Nd—Fe—B powder by atomization injection, so that the heavy rare earth is distributed on the surface of magnetic particles, and the magnetic properties are improved. However, the methods mentioned-above have much faultiness due to volatilization of organic solvent or a multistage grinding process to prepare the suspension, and the processes are relatively complex.

### SUMMARY OF THE DISCLOSURE

The present disclosure provides a manufacturing method of sintered Nd—Fe—B permanent magnet to overcome at least some of the drawbacks mentioned above. In the present disclosure, a uniformly modified coating is formed on the surface of the Nd—Fe—B powder by mechanical mixing, meanwhile, the Nd—Fe—B powder can be transformed into a circular one, and the distribution of grain boundary phase can be improved, so as to improve the coercive force of the magnet. In particular, the preparation method for improving the coercive force of a sintered Nd—Fe—B magnet according to the present disclosure comprises in the order the steps of:
A) preparing Nd—Fe—B alloy flakes by a strip casting process, followed by hydrogen decrepitation of the Nd—Fe—B alloy flakes and jet milling to obtain an Nd—Fe—B powder;
B) mixing Nd—Fe—B powder and an amount of 0.1 to 5 wt. % of a nanoparticulate powder in a powder mixing machine to obtain a powder mixture;
C) modification of the powder mixture obtained in step B) by applying mechanical energy under inert conditions in a mechanical mixing equipment such that the particles of the Nd—Fe—B powder are rounded and the nanoparticulate powder adheres to the particle surface of the Nd—Fe—B powder;
D) mixing in a lubricant to the modified Nd—Fe—B powder in a powder mixing machine; and
E) align pressing the modified Nd—Fe—B powder into a green body, sintering the green body, and aging of the obtained sintered Nd—Fe—B magnet.

A main aspect of the inventive process is the modification of the Nd—Fe—B powder in step C). In a suitable mixing device, e.g. a device for mechanical fusion (also known as mechanofusion), the nanoparticulate powder is adhered, maybe even embedded, into the larger particles of the Nd—Fe—B powder. This is achieved by applying mechanical energy, i.e. the system works with mechanical forces like impact and shear. During the process the particles of the Nd—Fe—B powder also rounded, i.e. the powder particles are subjected to extrusion, friction and shearing action, wherein sharp edges and corners of the powder particles are eroded. The particles of the nanoparticulate powder may be evenly distributed on the surface of Nd—Fe—B powder and form a coating layer. In other words, two sets of particles are employed and these two sets are distinguished by their average particle size. The mechanical mixing of step C) results in the formation of a shell comprised by the set of relatively smaller particles of the nanoparticulate powder around a core, comprised of the set of relatively larger particles of the Nd—Fe—B powder. Step C) thus leads to a novel powder composite material.

The Nd—Fe—B alloy flakes prepared by the strip casting process may comprise:

Nd and, optionally, one or more additional rare earth metals, wherein a total amount of the rare earth metals RE is in the range of 28 wt. %≤RE≤32 wt. %;

B being present in an amount of 0.8 wt. %≤B≤1.2 wt %;

M being one or more of Al, Cu, Mg, Zn, Co, Ti, Zr, Nb, and Mo, wherein a total amount of M is in the range of 0 wt. %≤M≤5 wt. %; and

the balance element is Fe.

Preferably, the further REs of the Nd—Fe—B powder are at least one of Pr, Dy, and Tb.

The strip casting process of step A) may be performed under inert conditions, e.g. under argon, and the melting temperature may be in the range of 1350° C. to 1500° C.

According to one embodiment, the Nd—Fe—B powder obtained by step A) has an average particle size of D50=2.5 μm to 5 μm. Independently or in addition thereto, the nanoparticulate powder may have an average particle size of D50=20 nm to 100 nm. The average particle diameter of the particles may be for example measured by a laser diffraction device using appropriate particle size standards. Specifically, the laser diffraction device is used to determine the particle diameter distribution of the particles, and this particle distribution is used to calculate the D50 average of particle diameters.

According to another embodiment, the nanoparticulate powder comprises a metal or an oxide selected from the group consisting of Dy, Tb, Nd, Pr, Al, Cu Mg, Zn, Ti, Zr, Nb, and Mo, or a combination thereof. Preferred are Dy, Nb, Cu, Al, DyCu alloys, such as Dy₇₀Cu₃₀, PrCu alloys, such as Pr₆₈Cu₃₂, and TiO₂, and combinations thereof.

According to another embodiment, an amount of the added lubricant in step D) is in the range of 0.05 to 0.2 wt. %.

According to another embodiment, in step E) while compressing the modified Nd—Fe—B powder during the align pressing an orienting magnetic field of 1.8 T to 2.5 T is applied.

According to another embodiment, in step E) the green body is sintered in a vacuum furnace at a temperature in the range of 950° C. to 1100° C. for 6 to 12 hours.

According to another embodiment, in step E) the sintered Nd—Fe—B achieved by sintering are subjected to an aging including a first heat treatment at 850° C. to 900° C. for 3 to 5 hours and a second heat treatment at 460° C. to 700° C. for 3 to 6 hours.

The following beneficial effects may result by the process of the present disclosure:

Nanoparticulate powder can be effectively coated on Nd—Fe—B powder under the action of mechanical force. During sintering and aging, the nanoparticulate powder at least partly fill the grain boundaries to improve the grain boundary phase distribution and strengthen the grain boundary, so as to reduce the magnetic coupling between the grains of the main phase and improve the magnetic properties.

The shape of Nd—Fe—B powder can be rounded, which is also helpful for improving the magnetic properties of magnets. Compared with a wet coating method, the dry coating method is simple and the mature reaction process is easy to control and does not require the use of organic solvents.

### BRIEF DESCRIPTION OF THE FIGURES

FIG. 1 is a scanning electron microscope (SEM) image of the Nd—Fe—B magnet according to Example 1 of the present disclosure.

FIG. 2 is a scanning electron microscope (SEM) image of the Nd—Fe—B magnet according to Comparative Example 1.

### DETAILED DESCRIPTION OF THE DISCLOSURE

In the following, further detailed descriptions of the present disclosure are given. It shall be noted that the embodiments are used only to interpret the present disclosure and do not have any limiting effect on it.

### EXAMPLE 1

The exemplary preparation method for preparing a sintered Nd—Fe—B magnet comprises the following steps:

Alloy sheets having the composition of (PrNd)₃₂Co₁Al_{0.35}Ti_{0.1}B_{1.0}Fe_{bal}(wt. %) are prepared by a strip casting process at the melting temperature of 1450° C., wherein the thickness of the alloy sheet is between 0.25 mm to 0.35 mm.

The alloy sheets are subjected to hydrogen decrepitation process to break the sheets into smaller pieces.

After the decrepitation process, the alloy pieces are pulverized in a jet milling process under nitrogen to prepare an alloy powder having an average particle size of about D50=2.5 μm.

An amount of 0.1 wt. % nanoparticulate copper powder is added into the Nd—Fe—B powder and then mixed in a powder mixing machine (3D mixer) for 2 hours. The nanoparticulate copper powder has an average particle size of about D50=20 nm.

Next, the powder mixture obtained in previous step is added to a mechanical mixing equipment (Mechanical fusing machine, Wuxi Xinguang Powder Technology Co., LTD). Modification of the powder mixture is performed under inert gas conditions, at a running speed of 2000 rpm for 60 min, and at a temperature of 25° C.

The modification conditions are such that the powder particles are subjected to extrusion, friction and shearing action in the mechanical mixing process, wherein the sharp edges and corners of the powder particles are eroded to improve powder roundness. Meanwhile, due to the high surface activation energy, the surface of Nd—Fe—B powder particle interacts with the nanoparticulate powder, which makes the nanoparticulate powder evenly distributed on the surface of Nd—Fe—B powder, and then forms a kind of coating layer.

After the mechanical mixing process, an amount of 0.1 wt. % lubricant is added into the modified Nd—Fe—B powder and mixed for 3 h in a 3D mixer, wherein the addition of lubricant is to prevent oxidation and is conducive to subsequent compression.

The modified Nd—Fe—B powder is compressed into compacts under the protection of nitrogen while applying an orienting magnetic field of 1.8 T.

The compacts are subjected to a sintering step in a vacuum furnace at a temperature of 1020° C. for 12 hours, then argon is pumped for rapid cooling.

Then, the sintered compacts are treated by a first heat treatment step at 850° C. for 3 hours, and a second heat treatment step at 660° C. for 6 hours.

### COMPARATIVE EXAMPLE 1

The production was carried out in the same manner as Example 1 except that no nanoparticulate copper powder is added and no modification by a mechanical mixing process is applied:

The alloy sheets have the composition (PrNd)₃₂Co₁Al_{0.35}Cu_{0.1}Ti_{0.1}B_{1.0}Fe_{bal}(wt. %) and are prepared by a strip casting process at the melting temperature of 1450° C., wherein the thickness of the alloy sheet is between 0.25 mm to 0.35 mm.

The alloy sheets are subjected to hydrogen decrepitation process to break the sheets into smaller pieces.

After the decrepitation process, the alloy pieces are pulverized in a jet milling process under nitrogen to prepare an alloy powder having an average particle size of D50=2.5 μm.

An amount of 0.1 wt. % lubricant is added into the Nd—Fe—B powder and mixed for 3 h in a 3D mixer, wherein the addition of lubricant is to prevent oxidation and is conducive to subsequent compression.

The Nd—Fe—B powder is compressed into compacts under the protection of nitrogen while applying an orienting magnetic field of 1.8 T.

The compacts are subjected to a sintering step in a vacuum furnace at a temperature of 1020° C. for 12 hours, then argon is pumped in for rapid cooling.

Then, the sintered compacts are treated by a first heat treatment step at 850° C. for 3 hours, and a second heat treatment step at 660° C. for 6 hours.

The magnetic properties of the magnets obtained in Embodiment 1 and Comparative Example 1 are shown in Table 1.

TABLE 1

| | Br(T) | Hcj(kA/m) | (BH)m(kJ/m³) | Hk/Hcj |
|---|---|---|---|---|
| Example 1 | 1.365 | 1637 | 354 | 0.98 |
| Comparative | 1.367 | 1441 | 355 | 0.98 |
| Example 1 | | | | |

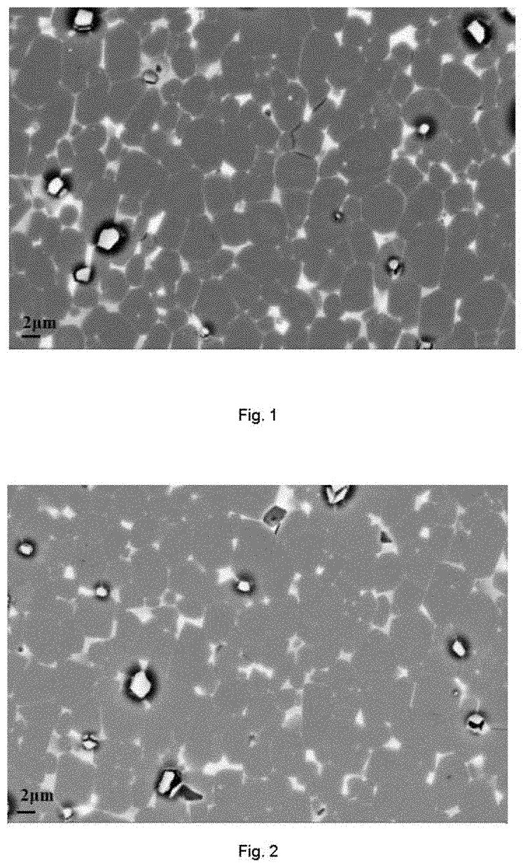

Compared with Comparative Example 1, the coercive force of the magnet in Example 1 increases from 18.1 KOe to 20.57 KOe. The magnet prepared by the method described in the present disclosure has a higher coercive force, which is due to the fact that the nanoparticulate copper reacts with the rare earth rich phase to form the copper rich phase with low melting point during the heat treatment. The distribution of grain boundary phase is improved, which makes the main phase grains separated, thus improving the coercivity of the magnet. The modifications caused by the inventive process are also illustrated by the SEM images of FIG. 1 (magnet of Example 1) and FIG. 2 (magnet of Comparative Example 1).

### EXAMPLE 2

The exemplary preparation method for preparing a sintered Nd—Fe—B magnet comprises the following steps:

The alloy sheets having the composition of (PrNd)_{29.5}Co₁Ga_{0.2}B_{1.0}Fe_{bal}(wt. %) are prepared by a strip casting process at the melting temperature of 1450° C., wherein the thickness of the alloy sheet is between 0.25 mm to 0.35 mm.

The alloy sheets are subjected to hydrogen decrepitation process to break the sheets into smaller pieces.

After the decrepitation process, the alloy powders are pulverized in a jet milling step under nitrogen to prepare an alloy powder having an average particle size of D50=4.0 μm.

The nanoparticulate powders of Dy₇₀Cu₃₀ (D50=50 nm) and TiO₂ (D50=20 nm) are added into the Nd—Fe—B powder and then mixed in a 3D mixer for 2 hours, wherein the addition amount converted into Dy and Ti is 0.5% and 0.1% of the weight of Nd—Fe—B, respectively.

Next, the mixing powder obtained in previous step is added to a mechanical mixing equipment and injected with inert gas at a running speed of 5000 rpm for 30 min under a temperature of 25° C.

After the mechanical mixing process, an amount of 0.1 wt. % lubricant is added into the modified Nd—Fe—B powder and mixed for 3 h in a 3D mixer.

The modified Nd—Fe—B powder is compressed into compacts under the protection of nitrogen while applying an orienting magnetic field of 1.8 T.

The compacts are subjected to a sintering step in a vacuum furnace at a temperature of 1060° C. for 12 hours, then argon is pumped for rapid cooling.

Then, the sintered compacts are treated by a first heat treatment step at 850° C. for 3 hours, and a second heat treatment step at 480° C. for 3 hours.

### COMPARATIVE EXAMPLE 2

Compared with Example 2, the mechanical mixing process of adding nanoparticulate powder is not performed in this Comparative Example, and the Nd—Fe—B magnet is prepared as follows:

The alloy sheets having the composition of (PrNd)_{29.5}Dy_{0.5}Co₁Cu_{0.1}Ga_{0.2}Ti_{0.1}B_{1.0}Fe_{bal} (wt. %) are prepared by a strip casting process at the melting temperature of 1450° C., wherein the thickness of the alloy sheet is between 0.25 mm to 0.35 mm.

The alloy sheets are subjected to hydrogen desorption process to break the sheets into more smaller pieces.

After the decrepitation process, the alloy powders are pulverized in a jet milling step under nitrogen to prepare an alloy powder having an average particle size of D50=4.0 μm.

An amount of 0.1 wt. % lubricant is added into the Nd—Fe—B powder and mixed for 3 h in a 3D mixer.

The Nd—Fe—B powder is compressed into compacts under the protection of nitrogen while applying an orienting magnetic field of 1.8 T.

The compacts are subjected to a sintering step in a vacuum furnace at a temperature of 1060° C. for 12 hours, then argon is pumped for rapid cooling.

Then, the sintered compacts are treated by a first heat treatment step at 850° C. for 3 hours, and a second heat treatment step at 480° C. for 3 hours.

The magnetic properties of the magnets obtained in Example 2 and Comparative Example 2 are shown in Table 2.

TABLE 2

| | Br(T) | Hcj(kA/m) | (BH)m(kJ/m³) | Hk/Hcj |
|---|---|---|---|---|
| Example 2 | 1.450 | 1418 | 412 | 0.98 |
| Comparative | 1.455 | 1235 | 408 | 0.98 |
| Example 2 | | | | |

Compared with Comparative Example 2, the remanence and coercivity of magnets in Example 2 are higher. Dy₇₀Cu₃₀ powder is coated on the surface of Nd—Fe—B powder by mechanical mixing, and (Pr,Nd,Dy)₂Fe₁₄B epitaxial layer is formed on the powder surface during heat treatment, which increases the magnetic crystal anisotropy field of the magnet, thus improving the coercivity of magnets. In addition, TiO₂ with high melting point oxide plays a pinning role in grain boundary and inhibits grain growth, which is also helpful to improve the coercivity of magnets.

### EXAMPLE 3

The exemplary preparation method for preparing a sintered Nd—Fe—B magnet comprises the following steps:

The alloy sheets having the composition of Nd₂₉Co₁Al_{0.1}Cu_{0.1}B_{1.0}Fe_{bal}(wt. %) are prepared by a strip casting process at the melting temperature of 1450° C., wherein the thickness of the alloy sheet is between 0.25 mm to 0.35 mm.

The alloy sheets are subjected to hydrogen desorption process to break the sheets into more smaller pieces.

After the decrepitation process, the alloy pieces are pulverized in a jet milling step under nitrogen to prepare an alloy powder having an average particle size of D50=4.0 μm.

Amount of 0.5 wt. % nanoparticulate Dy powder (D50=50 nm) and amount of 0.1 wt. % nanoparticulate Nb powder (D50=20 nm) are added into the Nd—Fe—B powder and then mixed in a 3D mixer for 2 hours.

Next, the mixing powder obtained in previous step is added to a mechanical mixing equipment and injected with inert gas at a running speed of 8000 rpm for 5 min under a temperature of 25° C.

After the mechanical mixing process, an amount of 0.1 wt. % lubricant is added into the nano-coated Nd—Fe—B powder and mixed for 3 h in a 3D mixer.

The nano-coated Nd—Fe—B powder is compressed into compacts under the protection of nitrogen while applying an orienting magnetic field of 1.8 T.

The compacts are subjected to a sintering step in a vacuum furnace at a temperature of 1070° C. for 6 hours, then argon is pumped for rapid cooling.

Then, the sintered compacts are treated by a first heat treatment step at 850° C. for 3 hours, and a second heat treatment step at 500° C. for 3 hours.

### COMPARATIVE EXAMPLE 3

Compared with Example 3, the mechanical mixing process of adding nanoparticulate powder is not performed in this comparative example, and the Nd—Fe—B magnet is prepared as follows:

The alloy sheets having the composition of Nd₂₉Dy_{0.5}Co₁Al_{0.1}Cu_{0.1}Nb_{0.1}B_{1.0}Fe_{bal}(wt. %) are prepared by a strip casting process at the melting temperature of 1450° C., wherein the thickness of the alloy sheet is between 0.25 mm to 0.35 mm.

The alloy sheets are subjected to hydrogen desorption process to break into more smaller pieces.

After the decrepitation process, the alloy powders are pulverized in a jet milling step under nitrogen to prepare an alloy powder having an average particle size of D50=4.0 μm.

An amount of 0.1 wt. % lubricant is added into the Nd—Fe—B powder and mixed for 3 h in a 3D mixer.

The Nd—Fe—B powder is compressed into compacts under the protection of nitrogen while applying an orienting magnetic field of 1.8 T.

The compacts are subjected to a sintering step in a vacuum furnace at a temperature of 1070° C. for 6 hours, then argon is pumped for rapid cooling.

Then, the sintered compacts are treated by a first heat treatment step at 850° C. for 3 hours, and a second heat treatment step at 500° C. for 3 hours.

The magnetic properties of the magnets obtained in embodiment 3 and Comparative Example 3 are shown in Table 3.

TABLE 3

| | Br(T) | Hcj(kA/m) | (BH)m(kJ/m³) | Hk/Hcj |
|---|---|---|---|---|
| Example 3 | 1.462 | 1314 | 416 | 0.98 |
| Comparative | 1.461 | 1137 | 415 | 0.98 |
| Example 3 | | | | |

As shown in Table 3, the magnet prepared by the disclosure has higher coercivity, which indicates that the coating of Nd—Fe—B powder by mechanical mixing has a good effect.

### EXAMPLE 4

The exemplary preparation method for preparing a sintered Nd—Fe—B magnet comprises the following steps:

The alloy sheets having the composition of (PrNd)_{29.8}Co_{1.5}Cu_{0.15}Ga_{0.2}Ti_{0.1}B_{1.0}Fe_{bal}(wt. %) are prepared by a strip casting process at the melting temperature of 1480° C., wherein the thickness of the alloy sheet is between 0.25 mm to 0.35 mm.

The alloy sheets are subjected to hydrogen desorption process to break the sheets into more smaller pieces.

After the decrepitation process, the alloy powders are pulverized in a jet milling step under nitrogen to prepare an alloy powder having an average particle size of D50=4.0 μm.

An amount of 0.2 wt. % nanoparticulate Tb powder (D50=20 nm) is added into the Nd—Fe—B powder and then mixed in a 3D mixer for 2 hours.

Next, the mixing powder obtained in previous step is added to a mechanical mixing equipment and injected with inert gas at a running speed of 350 rpm for 180 min under a temperature of 500° C.

After the mechanical mixing process, an amount of 0.2 wt. % lubricant is added into the nano-coated Nd—Fe—B powder and mixed for 3 h in a 3D mixer.

The nano-coated Nd—Fe—B powder is compressed into compacts under the protection of nitrogen while applying an orienting magnetic field of 1.8 T.

The compacts are subjected to a sintering step in a vacuum furnace at a temperature of 1050° C. for 12 hours, then argon is pumped for rapid cooling.

Then, the sintered compacts are treated by a first heat treatment step at 850° C. for 3 hours, and a second heat treatment step at 500° C. for 3 hours.

### COMPARATIVE EXAMPLE 4

Compared with Example 4, the mechanical mixing process of adding nanoparticulate terbium powder is not performed in this control group, and the Nd—Fe—B magnet is prepared as follows:

The alloy sheets having the composition of (PrNd)_{29.8}Tb_{0.2}Co₁Cu_{0.15}Ga_{0.2}Ti_{0.2}B_{1.0}Fe_{bal}(wt. %)

are prepared by a strip casting process at the melting temperature of 1480° C., wherein the thickness of the alloy sheet is between 0.25 mm to 0.35 mm.

The alloy sheets are subjected to hydrogen desorption process to break the sheets into more smaller pieces.

After the decrepitation process, the alloy powders are pulverized in a jet milling step under nitrogen to prepare an alloy powder having an average particle size of D50=4.0 μm.

An amount of 0.2 wt. % lubricant is added into the Nd—Fe—B powder and mixed for 3 h in a 3D mixer.

The Nd—Fe—B powder is compressed into compacts under the protection of nitrogen while applying an orienting magnetic field of 1.8 T.

The compacts are subjected to a sintering step in a vacuum furnace at a temperature of 1050° C. for 12 hours, then argon is pumped for rapid cooling.

Then, the sintered compacts are treated by a first heat treatment step at 850° C. for 3 hours, and a second heat treatment step at 500° C. for 3 hours.

The magnetic properties of the magnets obtained in Embodiment 4and Comparative Example 4 are shown in Table 4.

TABLE 4

| | Br(T) | Hcj(kA/m) | (BH)m(kJ/m³) | Hk/Hcj |
|---|---|---|---|---|
| Example 4 | 1.456 | 1441 | 409 | 0.98 |
| Comparative | 1.445 | 1262 | 399 | 0.98 |
| Example 4 | | | | |

As can be seen from Table 4, the magnets prepared by mechanically mixing modified Nd—Fe—B powder have higher magnetic properties. The terbium added by this method mostly exists in the surface layer of powder particles, so as to avoid the sharp decline of magnet Js resulting in the decrease of remanence. In addition, the rounding of Nd—Fe—B powder is also conducive to the improvement of magnetic remanence, which improves the magnetic remanence and coercivity.

### EXAMPLE 5

The exemplary preparation method for preparing a sintered Nd—Fe—B magnet comprises the following steps:

The alloy sheets having the composition of (PrNd)_{29.5}Co₁Al_{0.1}Cu_{0.1}B_{1.0}Fe_{bal}(wt. %) are prepared by a strip casting process at the melting temperature of 1450° C., wherein the thickness of the alloy sheet is between 0.25 mm to 0.35 mm.

The alloy sheets are subjected to hydrogen desorption process to break the sheets into more smaller pieces.

After the decrepitation process, the alloy powders are pulverized in a jet milling step under nitrogen to prepare an alloy powder having an average particle size of D50=5.0 μm.

An amount of 5 wt. % nanoparticulate Pr₆₈Cu₃₂ powder (D50=50 nm) is added into the Nd—Fe—B powder and then mixed in a 3D mixer for 2 hours.

Next, the mixing powder obtained in previous step is added to a mechanical mixing equipment and injected with inert gas at a running speed of 500 rpm for 180 min under a temperature of 300° C.

After the mechanical mixing process, an amount of 0.1 wt. % lubricant is added into the nano-coated Nd—Fe—B powder and mixed for 3 h in a 3D mixer.

The nano-coated Nd—Fe—B powder is compressed into compacts under the protection of nitrogen while applying an orienting magnetic field of 1.8 T.

The compacts are subjected to a sintering step in a vacuum furnace at a temperature of 950° C. for 12 hours, then argon is pumped for rapid cooling.

Then, the sintered compacts are treated by a first heat treatment step at 850° C. for 3 hours, and a second heat treatment step at 460° C. for 3 hours.

### COMPARATIVE EXAMPLE 5

Compared with Example 5, the mechanical mixing process of adding nanoparticulate Pr₆₈Cu₃₂ powder is not performed in this control group, and the Nd—Fe—B magnet is prepared as follows:

The alloy sheets having the composition of (PrNd)_{29.5}Co₁Al_{0.1}Cu_{0.1}B_{1.0}Fe_{bal}(wt. %) are prepared by a strip casting process at the melting temperature of 1450° C., wherein the thickness of the alloy sheet is between 0.25 mm to 0.35 mm.

The alloy sheets are subjected to hydrogen desorption process to break into more smaller pieces.

After the decrepitation process, the alloy powders are pulverized in a jet milling step under nitrogen to prepare an alloy powder having an average particle size of D50=5.0 μm.

An amount of 0.1 wt. % lubricant is added into the Nd—Fe—B powder and mixed for 3 h in a 3D mixer.

The Nd—Fe—B powder is compressed into compacts under the protection of nitrogen while applying an orienting magnetic field of 1.8 T.

The compacts are subjected to a sintering step in a vacuum furnace at a temperature of 950° C. for 12 hours, then argon is pumped for rapid cooling.

Then, the sintered compacts are treated by a first heat treatment step at 850° C. for 3 hours, and a second heat treatment step at 460° C. for 3 hours.

The magnetic properties of the magnets obtained in embodiment 5 and Comparative Example 5 are shown in Table 5.

TABLE 5

| | Br(T) | Hcj(kA/m) | (BH)m(kJ/m³) | Hk/Hcj |
|---|---|---|---|---|
| Example 5 | 1.392 | 1486 | 378 | 0.97 |
| Comparative | 1.451 | 1078 | 404 | 0.97 |
| Example 5 | | | | |

As can be seen from Table 5, the coercivity of the magnet prepared by the present disclosure is significantly improved, but the remanence is reduced more. This is because the proportion of addition is large, which increases the total amount of rare earth in the magnet, so the remanence decreases obviously.

### EXAMPLE 6

The differences with Example 1 are as follows: the rotating speed is 350 r/min, the time is 180 min, and the temperature is 500° C. in the mechanical mixing process. The test results are shown in Table 6.

### A) EXAMPLE 7

The differences with Example 1 are as follows: the rotating speed is 1000 r/min, the time is 150 min, and the temperature is 400° C. in the mechanical mixing process. The test results are shown in Table 6.

### EXAMPLE 8

The differences with Example 1 are as follows: the rotating speed is 4000 r/min, the time is 120 min, and the temperature is 300° C. in the mechanical mixing process. The test results are shown in Table 6.

### EXAMPLE 9

The differences with Example 1 are as follows: the rotating speed is 6000 r/min, the time is 80 min, and the temperature is 200° C. in the mechanical mixing process. The test results are shown in Table 6.

### COMPARATIVE EXAMPLE 6

The differences with Example 1 are as follows: the rotating speed is 200 r/min, the time is 80 min, and the temperature is 15° C. in the mechanical mixing process. The test results are shown in Table 6.

TABLE 6

| | Br(T) | Hcj(kA/m) | Hk/Hcj |
|---|---|---|---|
| Example 6 | 1.366 | 1504 | 0.98 |
| Example 7 | 1.398 | 1665 | 0.98 |
| Example 8 | 1.392 | 1654 | 0.98 |
| Example 9 | 1.385 | 1652 | 0.98 |
| Comparative | 1.353 | 1449 | 0.98 |
| Example 6 | | | |

### EXAMPLE 10

The difference from Example 1 is that the nanoparticulate powder is aluminum powder (the average particle size is 20 nm, and the weight ratio to Nd—Fe—B powder is 0.1%). The test results are shown in Table 7.

### EXAMPLE 11

The difference from Example 1 is that the nanoparticulate powder is Dy powder (the average particle size is 50 nm, and the weight ratio to Nd—Fe—B powder is 0.1%) and Nb powder (the average particle size is 20 nm, the weight ratio to Nd—Fe—B powder is 0.1%). The test results are shown in Table 7.

### EXAMPLE 12

The difference from Example 1 is that the nanoparticulate powder is Pr₆₈Cu₃₂ powder (the average particle size is 50 nm, and the weight ratio to Nd—Fe—B powder is 0.1%). The test results are shown in Table 7.

### EXAMPLE 13

The difference from Example 1 is that the nanoparticulate powder is Dy₇₀Cu₃₀ powder (the average particle size is 50 nm, and the weight ratio to Nd—Fe—B powder is 0.1%) and TiO₂ powder (the average particle size is 20 nm, the weight ratio to Nd—Fe—B powder is 0.1%). The test results are shown in Table 7.

TABLE 7

| | Br(T) | Hcj(kA/m) | Hk/Hcj |
|---|---|---|---|
| Example 10 | 1.345 | 1540 | 0.98 |
| Example 11 | 1.372 | 1676 | 0.98 |
| Example 12 | 1.360 | 1648 | 0.98 |
| Example 13 | 1.375 | 1660 | 0.98 |

1. A preparation method for improving the coercive force of a sintered Nd—Fe—B magnet, the method comprising in the order the steps of:
A) preparing Nd—Fe—B alloy flakes by a strip casting process, followed by hydrogen decrepitation of the Nd—Fe—B alloy flakes and jet milling to obtain an Nd—Fe—B powder;
B) mixing Nd—Fe—B powder and an amount of 0.1 to 5 wt. % of a nanoparticulate powder in a powder mixing machine to obtain a powder mixture;
C) modification of the powder mixture obtained in step B) by applying mechanical energy under inert conditions in a mechanical mixing equipment such that the particles of the Nd—Fe—B powder are rounded and the nanoparticulate powder adheres to the particle surface of the Nd—Fe—B powder;
D) mixing in a lubricant to the modified Nd—Fe—B powder in a powder mixing machine; and
E) align pressing the modified Nd—Fe—B powder into a green body, sintering the green body, and aging of the obtained sintered Nd—Fe—B magnet.

2. The method of claim 1, wherein the Nd—Fe—B alloy flakes comprise:
Nd and, optionally, one or more additional rare earth metals, wherein a total amount of the rare earth metals RE is in the range of 28 wt. %≤RE≤32 wt. %;
B being present in an amount of 0.8 wt. %≤B≤1.2 wt %;
M being one or more metal selected from the group consisting of Al, Cu, Mg, Zn, Co, Ti, Zr, Nb, and Mo, wherein a total amount of M is in the range of 0 wt. %≤M≤5 wt. %; and
the balance element is Fe.

3. The method of one of claim 1, wherein the Nd—Fe—B powder obtained by step A) has an average particle size of D50=2.5 μm to 5 μm.

4. The method of one of claim 1, wherein the nanoparticulate powder has an average particle size of D50=20 nm to 100 nm.

5. The method of claim 1, wherein the nanoparticulate powder comprises a metal or an oxide selected from the group consisting of Dy, Tb, Nd, Pr, Al, Cu Mg, Zn, Ti, Zr, Nb, and Mo, or a combination thereof.

6. The method of claim 1, wherein an amount of the added lubricant in step D) is in the range of 0.05 to 0.2 wt. %.

7. The method of claim 1, wherein in step E) while compressing the modified Nd—Fe—B powder during the align pressing an orienting magnetic field of 1.8 T to 2.5 T is applied.

8. The method of claim 1, wherein in step E) the green body is sintered in a vacuum furnace at a temperature in the range of 950° C. to 1100° C. for 6 to 12 hours.

9. The method of claim 1, wherein in step E) the sintered Nd—Fe—B achieved by sintering are subjected to an aging including a first heat treatment at 850° C. to 900° C. for 3 to 5 hours and a second heat treatment at 460° C. to 700° C. for 3 to 6 hours.

10. The method of claim 2, wherein the Nd—Fe—B powder obtained by step A) has an average particle size of D50=2.5 μm to 5 μm.

11. The method of claim 3, wherein the nanoparticulate powder has an average particle size of D50=20 nm to 100 nm.

12. The method of claim 11, wherein the nanoparticulate powder comprises a metal or an oxide selected from the group consisting of Dy, Tb, Nd, Pr, Al, Cu Mg, Zn, Ti, Zr, Nb, and Mo, or a combination thereof.

13. The method of claim 12, wherein an amount of the added lubricant in step D) is in the range of 0.05 to 0.2 wt. %.

14. The method of claim 13, wherein in step E) while compressing the modified Nd—Fe—B powder during the align pressing an orienting magnetic field of 1.8 T to 2.5 T is applied.

15. The method of claim 14, wherein in step E) the green body is sintered in a vacuum furnace at a temperature in the range of 950° C. to 1100° C. for 6 to 12 hours.
